(19) United States
(12) Patent Application Publication
(10) Pub. No.: US 2014/0244573 A1
(43) Pub. Date: Aug. 28, 2014

(54) DATA WAREHOUSE WITH CLOUD FACT TABLE

(71) Applicant: Allan Michael Gonsalves, San Jose, CA (US)

(72) Inventor: Allan Michael Gonsalves, San Jose, CA (US)

(21) Appl. No.: 14/146,715

(22) Filed: Jan. 2, 2014

Related U.S. Application Data
(60) Provisional application No. 61/770,313, filed on Feb. 27, 2013.

(51) Int. Cl. G06F 17/30

(52) U.S. Cl. CPC G06F 17/30592
USPC 707/606

(57) ABSTRACT

A data warehouse includes plurality of master data tables, a plurality of dimension tables and a fact table. The master data tables including surrogate identifiers. The dimension tables use the surrogate identifiers to link to the master data table domains within the master data tables. The fact table stores dimension identifiers that provide links to the master data tables. A cloud storage area includes a plurality of cloud dimension tables and a cloud fact table. Each cloud dimension table stores summary characteristics. Each cloud dimension table associates a separate cloud identifier with each entry of summary characteristics. The cloud fact table stores aggregated data representing key performance indicators. The cloud fact table includes a plurality of cloud identifier columns in which cloud identifiers are stored. Each cloud identifier column is dedicated to a single associated cloud dimension table from the plurality of cloud dimension tables, so that each cloud identifier column only stores cloud identifiers for a single cloud dimension table.

### BACKGROUND

A data warehouse is a repository of an organization's electronically stored data, designed to facilitate reporting and analysis. It is also a nonvolatile data repository that houses large amounts of historical data. Data warehousing and associated processing mechanisms, such as Online Analytical Processing (OLAP), Relational OLAP (ROLAP), Multidimensional OLAP (MOLAP), and Hybrid OLAP (HOLAP), are common technologies used to support business decisions and data analysis. There are two leading approaches used to store data in a data warehouse—the dimensional approach and the normalized approach.

In a dimensional approach, transaction data are partitioned into either “facts”, which are generally numeric transaction data such as net sales, quantity sold, gross sales, etc, or “dimensions”, which are the reference information that gives context to the facts. In the normalized approach, the data in the data warehouse are stored following, to a degree, data normalization rules. Tables are grouped together by subject areas that reflect general data categories, such as data on customers, products, finance, etc. Dimensional approaches can involve normalizing data to a degree.

Dimensional data warehouses and data marts sometimes use tables logically arranged in a star schema or snowflake schema. The snowflake schema is represented by centralized fact tables that are connected to multiple dimension tables or dimensions are normalized into multiple related tables or sub-dimension tables. Each dimensional table represents a data dimension of the warehouse. All the data for a data dimension can be stored in the associated dimension table, or can be stored in one or more master data tables associated with the dimension table. A typical objective when using the snowflake schema is to remove low cardinality attributes from a dimension table and place these attributes in a secondary dimension table.

In a snowflake schema, the master data tables can all be directly connected to an associated dimension table, or can be arranged more elaborately with multiple levels of master data tables arranged connected in parent and child relationships, and where child tables may have multiple parent tables, thus resulting in a complex snowflake like arrangement. The term “Master Data” means the enterprise-spanning set of data arising or processed within all of the enterprise's primary business entities and functions. For example, in supply chain applications, master data includes product identifiers and details, suppliers, components, inventory, costs, and so on.

When a query to a dimensional data warehouse is based on data stored in a master data table, the master data table is searched to obtain the master data table identifier for the data. The master data table identifier is often referred to as a surrogate identifier (SID). Once the surrogate identifier for the data has been obtained, data to fulfill the query can be obtained from tables in the data warehouse. This data may be located, for example, in a fact table, one or more dimension tables, and one or more master data tables. When a master data table is large, searching through the master data table to obtain a surrogate key or identifier can be a relatively time consuming process. Typically executive level reporting or cloud reporting requirements is to get the summarized view or aggregated view of data such as measures that can help executives to get visibility on corporate measures without having to get transactional level details. This requirement may not require data warehouse to use snowflake or star schema model due to the fact that volume of the data is so high that it can lead to query performance issue.

Typical snowflake or start schema is designed to capture transactional record or grain to track end-to-end transaction details such as purchase details of the particular product by specific customer for certain price and other details however executive report may report to see how much was net revenue generated from Asia region for specific product in first quarter of the year.

### BRIEF DESCRIPTION OF THE DRAWINGS

FIG. 1 is a simplified block diagram illustrating a computing system making queries to a cloud data warehouse in accordance with the prior art.

FIG. 2 shows data in data warehouse being arranged in a multiple dimensional snowflake schema with an additional cloud fact table and cloud dimension table in accordance with an embodiment.

FIG. 3 is a simplified example of tables within a cloud data warehouse in accordance with an embodiment.

FIG. 4 illustrates processing of a query into a cloud fact table in accordance with an embodiment.

FIG. 5 illustrates processing and insertion of data into a cloud domain fact table and cloud dimension table in accordance with an embodiment.

FIG. 6 summarizes a process to build a cloud fact table and cloud dimension table in accordance with an embodiment of the invention.

### DESCRIPTION OF THE EMBODIMENT

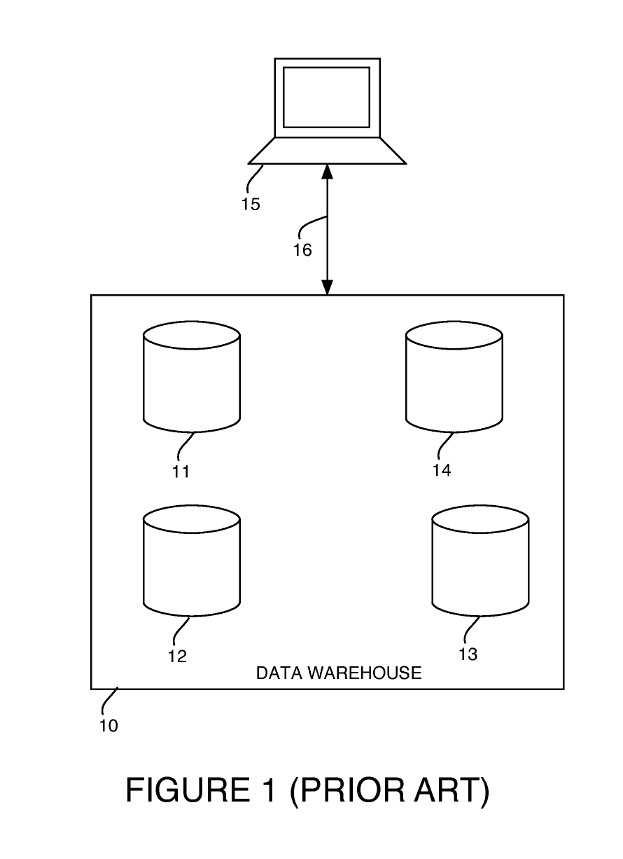

FIG. 1 is a simplified block diagram illustrating connection of a computer system 15 with a data warehouse 10. Data warehouse 10 is organized to meet the need for reliable, consolidated, unique and integrated reporting and analysis, at different levels of aggregation, of the data for an organization. A data warehouse is typically made up of a collection of one or more data repositories. This is illustrated in FIG. 1 by data warehouse 10 including a data repository 11, a data repository 12, a data repository 13 and a data repository 14. For example, data repository 11 includes customer details, data repository 12 includes employee files, data repository 13 includes sales and manufacturing information, data repository might 14 includes financial data. Other data, such as financial information, can be stored in additional data repositories.

Data warehouse 10 integrates the data system to facilitate the answer of data queries from a user of the data warehouse. This is illustrated in FIG. 1 by arrow 16 which represents a user on computer 15 making a query into data warehouse 10 and obtaining a reply.

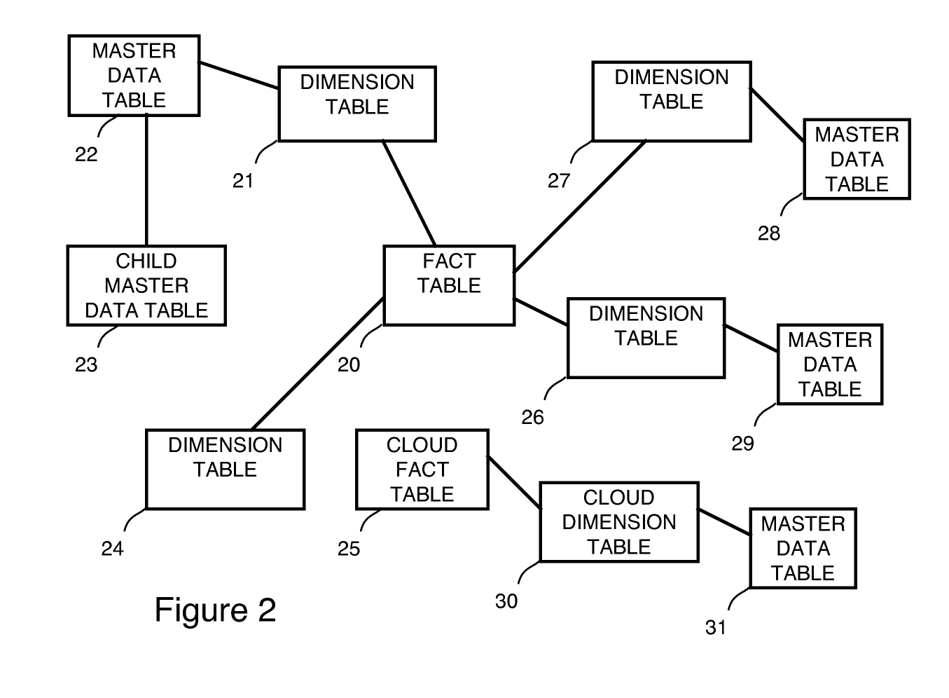

FIG. 2 gives additional information about how data warehouse 10 is organized. In this example, data warehouse 10 is organized in a snowflake schema. In the snowflake schema a centralized fact table 20 is connected to multiple dimension tables, represented in FIG. 2 by a dimension table 21, a dimension table 27, a dimension table 26 and a dimension table 24. Each dimensional table represents a data dimension of the warehouse. For example, the dimension represented by dimension table 21 is for the customer information stored in data repository 11. The dimension represented by dimension table 27 is for the sales information stored in data repository 13. The dimension represented by dimension table 24 is for the financial information stored in data repository 14. Another dimension table 26 is for the employee information stored in data repository 12.

While dimension tables can store user generated data, often times dimension tables are used primarily to store surrogate identifiers that point to user data stored in the master tables associated with the dimension table. Each surrogate identifier identifies a master data table domain inside a master data table. The dimension tables use the surrogate identifiers to link to the master data table domains. For example, customer information is stored in a master data table 22 and a child master data table 23 of master data table 22, not directly in dimension table 21. Sales information is stored in a master data table 28. Employee information is stored in a master data table 29. Dimension tables can additionally store keys that link to entries within the plurality of master data tables.

FIG. 2 is only meant to be illustrative of the organization of a data warehouse. A typical data warehouse may be much more complex than is shown by FIG. 2 while still conforming to the overall snowflake schema represented in FIG. 2.

In a typical snowflake schema, each data entry in a fact table will reference one or more dimension identifiers (DIM identifiers) into a dimension table data entry. Each data entry in a dimension table will be stamped for identification with a DIM identifier and will contain one or more surrogate identifiers (SIDs) into a master data table data entry. Each data entry in a master data table will be stamped for identification with an SID and will contain data entries such as attributes, navigational attributes, compound attributes, hierarchy identifiers and text identifiers.

Data warehouses, such as data warehouse 10, are generally organized to provide operational level reporting. In order to obtain information from master data table 29 a DIM identifier from fact table 20 is used to link to DIM identifier of dimension table 26 which also has SID identifier stored. The SID accessed from dimension table 26 is then used to access data stored in master data table 29. Likewise, to obtain information from master data table 28, a DIM identifier from fact table 20 is used to link to DIM identifier of dimension table 27. Dimension table 27 also stores a SID identifier. The SID identifier accessed from dimension table 27 is used to access data stored in master data table 28.

This process of obtaining information from a fact table is often time consuming. This is because there can be multiple table look-ups involved which can slow down query performance. Also dimension tables and fact tables often store a huge volume of operational data records, which take time to search through. Slow response time does not always meet the needs of high level management which is often interested in quickly accessing, for tracking purposes, a few key performance indicators. Examples of key performance indicators can be, for example, gross sale by customer, gross sale by product, gross sale by region, gross sale by country, net revenue per quarter, top ten customer report, top ten product report, and so on.

Because data warehouse 10 stores a lot of information in addition to the key performance indicators, the overhead and processing time required to assemble reports on key performance indicators can be very high. To expedite access to key performance data required, for example, for executive reporting needs, key performance indicators can be aggregated and stored in a cloud storage area of data warehouse 10. For example, FIG. 2 shows data warehouse 10 including a cloud fact table 25 and cloud dimension table 30 used to accommodate executive recording needs. A technical infrastructure is used to perform functions on data in the cloud storage area. The functions include data read, data write, authorization of data access, broadcast of data, validation of data, execution operations using data and generating reports and other business related tasks.

Cloud fact table 25 is used to aggregate transaction data. The transaction data is also stored at master data object level, for example in dimension tables, master data tables or child master data tables located elsewhere in data warehouse 10. For example, the aggregated data stored in cloud fact table 25 are key performance indicators defined to provide reports to high level management of a company. The aggregation level can be defined and generated to meet specific reporting needs to report on a specific application data set. The application data set can be, for example, related to sales and distribution, production planning, financial planning or reporting and so on. Aggregated transaction data is aggregated from a subset of data stored in cloud dimension tables. The aggregated data is accessible from the cloud fact table using cloud identifiers, without a necessity of using dimension identifiers.

Cloud dimension table 30 can be defined dynamically based on a user reporting requirements. Cloud dimension table 30 stores summary characteristics and may include technical objects used to set up an underlying technical architecture to support quick data retrieval. For example, suppose a user requires reporting on total sales revenue within the United States resulting from sales of a mini processor to a large pharmaceutical customer. In this case, cloud dimension table 30 might consist of all the characteristics necessary to satisfy this reporting requirement. A cloud identifier (ID) is used to link the data within cloud dimension table 30 to cloud fact table 25. The cloud identifier from dimension table 30 can be used to quickly access total sales revenue records from cloud fact table 25. S Data in cloud fact table 25 are stored and accessed based on cloud identifiers and key performance indicators (KPIs). Dimension identifiers (DIM identifiers) are not used when accessing data from cloud fact table 25. This facilitates expedited access and retrieval of data queries to cloud fact table 25 because the existence of data in cloud fact table 25 makes unnecessary the access of the underlying tables within data warehouse 10 that store all the operational details not desired when accessing key performance indicators. Cloud fact table 25 aggregates pertinent operational details into master data significantly reducing the data actually stored in cloud fact table 25. A mix of master data keys and Surrogate identifiers can be stored in the cloud dimension tables within the plurality of cloud dimension tables.

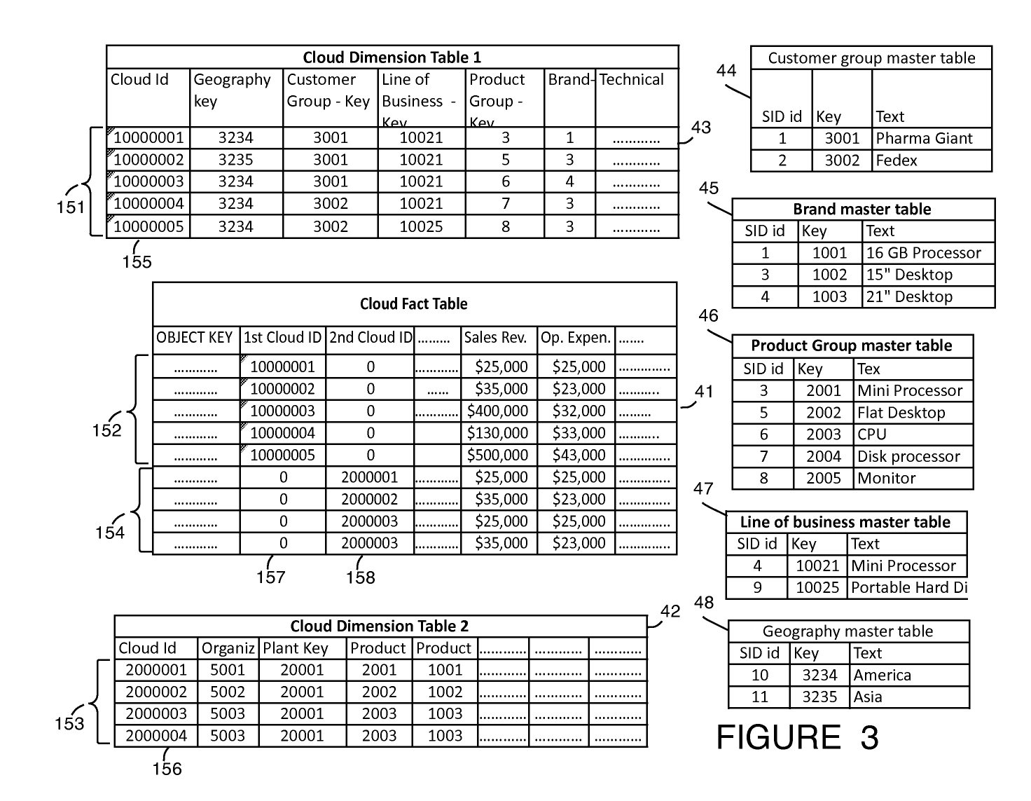

FIG. 3 is an example of organization of data within a data warehouse that includes a cloud fact table 41, a cloud dimension table 42 and a cloud dimension table 43. Pertinent data to information stored in cloud fact data table can be stored in other tables within data warehouse 10. For example, a master data table 44 includes information about customers, a master data table 45 contains information about brands, a master data table 46 includes information about product groupings, a master data table 47 includes information about the line of business and a master data table contains information about geography. The master tables shown in FIG. 3 are extremely abbreviated for ease of explanation. For example, in FIG. 3, customer group master data table 44 shows only three columns. Typically, a customer group master data table would include a lot of additional information. For example, the addition information could include, for example, the name of the customer, the city in which the customer is located, customer address and so on. This additional information is often referred to as data attributes.

As illustrated by FIG. 3, a user can define and drive the design of cloud dimension table 43 and cloud dimension table 42 based on the user's reporting requirements. Cloud dimension tables 42 and 43 can consist of only necessary characteristics that are needed to satisfy the reporting needs of the user. Alternatively or in addition, a cloud dimension table can consist of technical objects to set up underlying technical architecture of the system to support quick data retrieval at the time query is fired to request information in report. For example, cloud dimension tables and cloud fact table 41 are populated with external data or date from an existing data warehouse.

To speed up the process of obtaining key performance indicator data from cloud fact table 41, a separate column in cloud fact table 41 is created for each cloud dimension table. For example, cloud dimension table 43 stores cloud identifiers for entries 151 in a cloud identifier column 155. Cloud fact table 41 stores cloud identifiers for cloud dimension table 43 in dedicated column 157. Only cloud identifiers from cloud dimension table 43 are stored in dedicated column 157. As shown in FIG. 3, entries 152 all include cloud identifiers from cloud dimension table 43. Other entries in cloud fact table 41 that do not include cloud identifiers from dimension able 43 have a value of zero within dedicated column 157. This allows cloud fact table 41 to be very quickly searched for cloud identifiers from cloud dimension table 43.

Likewise, cloud dimension table 42 stores cloud identifiers for entries 153 in a cloud identifier column 156. Cloud fact table 41 stores cloud identifiers for cloud dimension table 42 in dedicated column 158. Only cloud identifiers from cloud dimension table 42 are stored in dedicated column 158. As shown in FIG. 3, entries 154 all include cloud identifiers from cloud dimension table 42. Other entries in cloud fact table 41 that do not include cloud identifiers from dimension able 42 have a value of zero within dedicated column 158. This allows cloud fact table 41 to be very quickly searched for cloud identifiers from cloud dimension table 42.

The column based data retrieval illustrated by FIG. 3 can help to speed up performance of a query. In addition to cloud identifiers, cloud dimension tables 30 can store keys or other identifiers, such as SID id, to allow access of master tables within the data warehouse. Typically, keys in master data table are used to represent specific master data text values. For example in table 44, key 3002 is used to represent customer FedEx. In FIG. 3, entries in cloud dimension table 43 include geography keys for access of data within master data table 48, include customer group keys for access of data within master data table 44, include line of business keys for access of data within master data table 47, include product group SID identifier for access of data within master data table 46 and include brand SID identifiers keys for access of data within master data table 45.

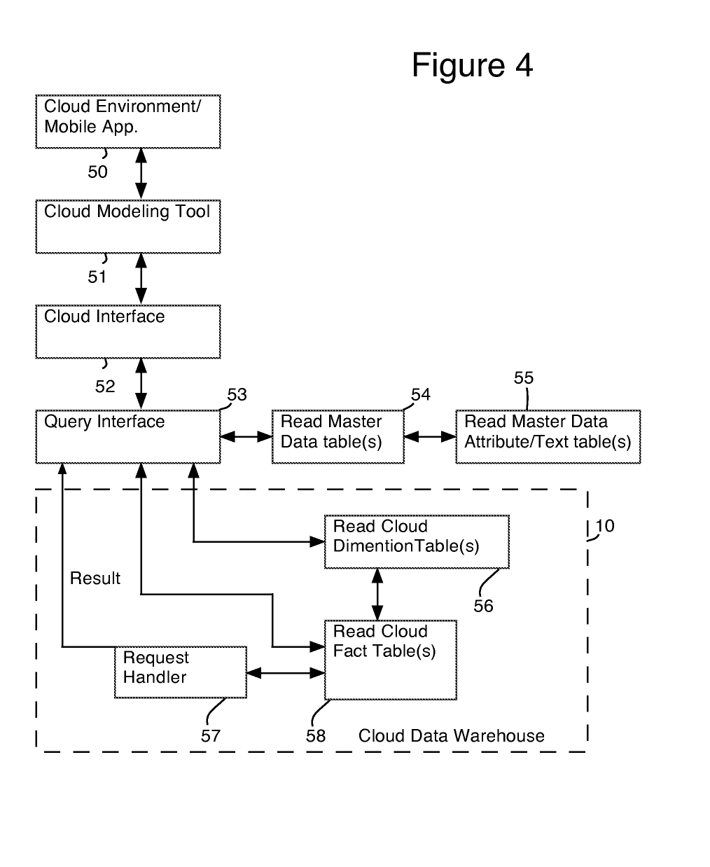

FIG. 4 illustrates a processing of a query to obtain information from cloud fact table 25, shown in FIG. 2. A user accesses a cloud environment mobile application 50 to construct a cloud report or query to make a request for data. Cloud environment mobile application 50, or another cloud environment mobile application can be used to easily and quickly access data and report data. For example, a query performs master data retrieval and facilitates an end-to-end data movement between the plurality of master data tables and the plurality of cloud dimension tables. The query also performs data validation to support user query needs.

The cloud report or query is designed in a cloud modeling tool 51. Cloud modeling tool 51 passes on a user defined cloud definition and technical details to a cloud interface 52. Cloud interface 52 sets up a technical architecture and sets up cloud identifier generation for the query. Additionally cloud interface 52 can be used to set up a data processing approach and business rules to be followed during population of the cloud fact table 25, cloud dimension table 30 and additional cloud dimension tables (not shown). The cloud interface can also build mapping rules, perform validations and perform data load processing

Cloud Interface 52 passes control to a query interface 53. Query interface 53 reads from master data object details from read master data table(s) 54 and reads master data attribute/text tables 55 to obtain any necessary text or other details needs to satisfy user query results.

Query Interface 53 will use information from cloud interface 52 and/or master table(s) 54 and master data attribute/text tables 55 to obtain cloud identifiers for the query from cloud dimension table 30. The column within cloud fact table 25 that is dedicated to storing entries for cloud dimension table 30 is then searched by reading cloud dimension table function 56 and cloud fact table function 58 for the cloud identifier that identifies data within cloud fact table 25 that are needed to satisfy the query.

Additional cloud identifiers from other cloud dimension tables (not shown in FIG. 2) can also be accessed and used to search the column within cloud fact table 25 that is dedicated to store entries for each cloud dimension table. Using the cloud identifier to search the dedicated column, the additional data that are needed to satisfy the query can be accessed from within cloud fact table 25.

The data obtained from cloud fact table 25 using the cloud identifier(s) is passed on to request handler 57 along with information about characteristics obtained from the appropriate cloud dimension table. Characteristics can include, for example, the information stored in cloud dimension table 43 such as a geography key, a customer group key, align of business key and so on. Request handler 57 passes the details to query Interface 53 to perform data validations and check before it is passed to cloud interface 52, to cloud modeling tool 51 and then to cloud environment/mobile applications 50 to return requested query results to the user.

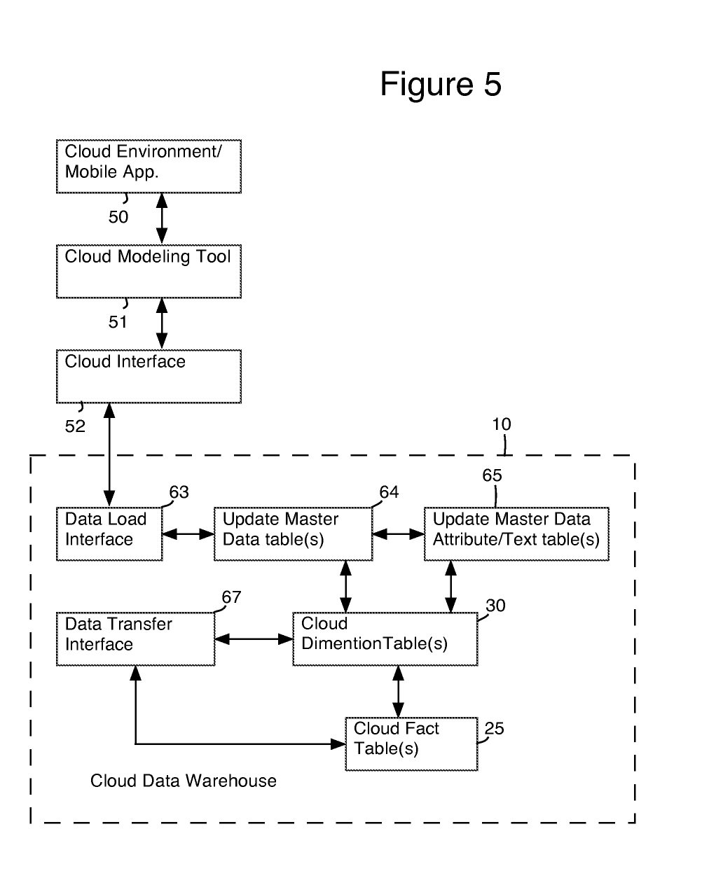

FIG. 5 illustrates processing and insertion of data into cloud fact table 25 and cloud dimension table 30. A user accesses cloud environment/mobile applications 50 to define cloud definition prior to loading any data in the cloud fact table 25 and cloud dimension table 30.

A cloud modeling tool 51 is used by a user to set up technical definitions, data processing approach and business rules. Based on details obtained from cloud modeling tool 51, cloud interface 52 sets up a technical architecture of the cloud tables. For example, the technical definitions can include fact table definition including technical name, generation requirements, authorization requirements and so on. The technical definitions can also include setting up a data integration or linkage between cloud fact table 25 and cloud dimension table 30 using a cloud identifier. Specification of a data processing approach indicates whether data for cloud fact table 25 is obtained from a data source external from data warehouse 10 or whether the data is obtained from within tables already existing in data warehouse 10. Business rules can include data load scheduling options such as event set up, time of execution and other technical options to facilitate the data load pr. Business rules can also include rules for data archiving and data maintenance. Business rules also can include, for example, a setting that data is to be loaded as a full load, where all data is erased and replaced, or as a delta load where changes in data rows are made without erasing all data in a row.

Cloud interface 52 is also used to identify data objects (e.g., master data objects) and to set up validation rule and data filter conditions used for cloud fact table 25 and cloud dimension table 30. Cloud interface 52 is also used to determine if existing data from data warehouse 10 is to be populated from data already within data warehouse 10, or populated from an external data source.

A data load interface unit 63 processes data based on the business rules, the technical definitions and the data processing approach driven by cloud interface unit 52 and cloud modeling tool 51. Data load interface unit 63, for example, performs master data object validations, performs SID identifier retrieval from within data warehouse 10, performs retrieval of data from existing tables that is to be aggregated into key performance indicators and obtains data from external sources that is aggregated or converted into key performance indicators, aggregation, and so. Data load interface 63, for example, operates in the background and is not directly accessible by a user.

A data transfer Interface 67 takes control from data load interface 63 and performs field level mapping rules to place necessary master data characteristics and other technical objects into cloud dimension table 30. This process also identifies a numeric cloud identifier to be placed in the cloud dimension 30 for each combination of data record.

Data transfer interface 67 performs checks and validation on measures and overall data records before inserting each data record into cloud fact table 25. One of the main task that data transfer interface 67 performs is to set up for each cloud dimension table a dedicated column to store cloud identifiers for the dimension able. The resulting cloud model will reflect the respective cloud model set up by the user in cloud modeling tool 51. Data transfer interface 67 keeps all other columns populated with some identifier or zero value so that those column can be used for other cloud reporting requirements. Data transfer interface 67 controls addition or delta update to cloud fact table 25. Data transfer interface 67 also handles exception scenarios and appropriate error messaging or log generation.

Data transfer interface 67 is also responsible for ensuring cloud fact table 25, for example, is supported by a compression, archiving and back up storage strategy. Compressing, archiving, and indexing data in cloud fact table 25 and/or cloud dimension table 30 can assist in obtaining better query read and data load performance process.

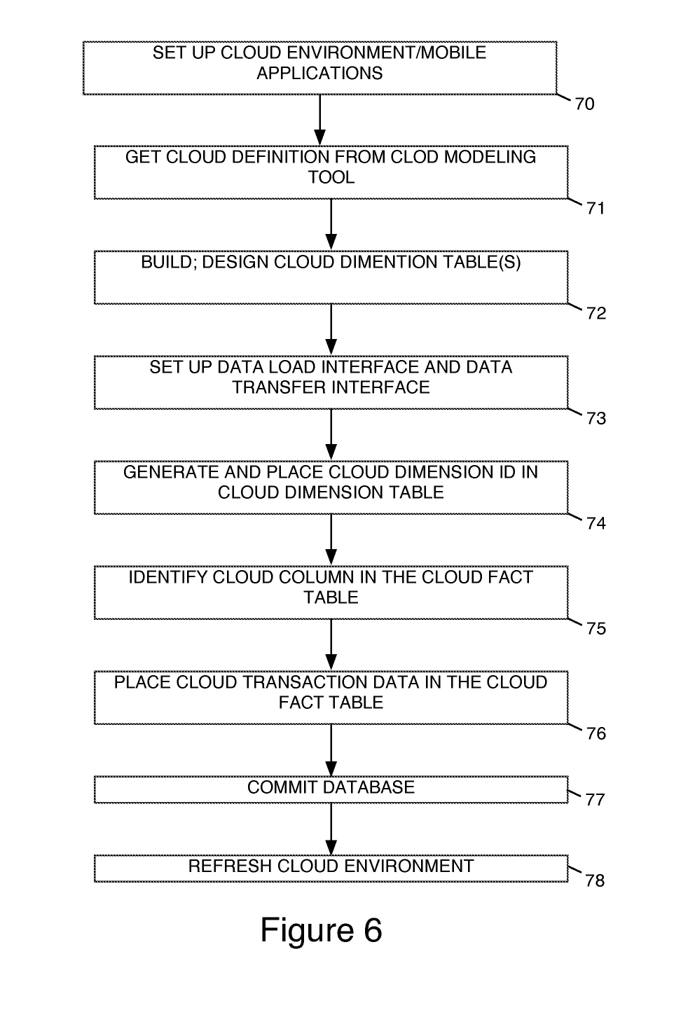

FIG. 6 summarizes a process to build cloud fact table 25. In a block 70, a cloud environment or mobile applications are set up. For example, this requires installation of software and hardware components to support data retrieval and reporting applications. In a block 71, a user defines cloud definitions and other mechanisms in the cloud modeling tool.

In a block 72, based on cloud definitions, a system design or builds the cloud dimension table(s).

In a block 73, data load interface and data transfer interfaces facilitate the data movements.

In a block 74, cloud identifiers are generated and placed in cloud dimension table(s) and cloud fact table(s).

In a block 75, cloud columns are identified in the cloud fact table(s). In a block 76, cloud transactions are placed into the cloud fact table(s).

In a block 77, data records are committed to the database. In a block 78, cloud environment or mobile applications are refreshed to pull the required reporting or business related information.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. A data warehouse comprising:
a plurality of master data tables, the master data tables including surrogate identifiers, each surrogate identifier identifying a master data table domain inside a master data table from the plurality of master data tables;
a plurality of dimension tables, the dimension tables using the surrogate identifiers to link to the master data table domains within the master data tables;
a fact table, the fact table storing dimension identifiers that provide links to dimension tables in the plurality of dimension tables; and,
a cloud storage area, including
a plurality of cloud dimension tables, each cloud dimension table storing summary characteristics and each cloud dimension table associating a separate cloud identifier with each entry of summary characteristics, and
a cloud fact table, the cloud fact table storing aggregated data representing key performance indicators, the cloud fact table including a plurality of cloud identifier columns in which cloud identifiers are stored, wherein each cloud identifier column is dedicated to a single associated cloud dimension table from the plurality of cloud dimension tables, so that each cloud identifier column only stores cloud identifiers for a single cloud dimension table and does not store dimension identifiers.

2. A data warehouse as in claim 1 wherein each cloud dimension table additionally stores keys that link to entries within the plurality of master data tables.

3. A data warehouse as in claim 1 wherein the plurality of cloud dimension tables include technical objects used to set up an underlying technical architecture to support quick data retrieval.

4. A data warehouse as in claim 1, additionally comprising:
applications through which data and reporting data can be easily and quickly accessed.

5. A data warehouse as in claim 1, additionally comprising:
a cloud interface unit through which a user sets up technical definitions, data processing approach and business rules to be followed during population of the cloud fact table and the plurality of cloud dimension tables.

6. A data warehouse as in claim 5, additionally comprising:
a data load interface; and,
a data transfer interface; wherein the data load interface and the data transfer interface act as a bridge between the cloud interface unit and the plurality of cloud dimension tables.

7. A data warehouse as in claim 5 wherein the cloud interface builds mapping rules, performs validations and performs data load processing.

8. A method for organizing and accessing data in a cloud data warehouse, the method comprising:
arranging the data in a plurality of master data tables, the master data tables including surrogate identifiers, each surrogate identifier identifying a master data table domain inside a master data table from the plurality of master data tables; and,
setting a cloud storage area, the cloud storage area including
a plurality of cloud dimension tables, each cloud dimension table storing summary characteristics and each cloud dimension table associating a separate cloud identifier with each entry of summary characteristics, and
a cloud fact table, the cloud fact table storing aggregated data representing key performance indicators, the cloud fact table including a plurality of cloud identifier columns in which cloud identifiers are stored, wherein each cloud identifier column is dedicated to a single associated cloud dimension table from the plurality of cloud dimension tables, so that each cloud identifier column only stores cloud identifiers for a single cloud dimension table.

9. A method as in claim 8 additionally comprising:
storing a mix of master data keys and Surrogate identifiers in the cloud dimension tables within the plurality of cloud dimension tables.

10. A method as in claim 8 additionally comprising:
storing only surrogate identifiers of the master data objects in the cloud dimension tables within the plurality of cloud dimension tables.

11. A method as in claim 8 additionally comprising:
storing only master data keys with no surrogate identifiers of the master data in the cloud dimension table.

12. A method as in claim 8 additionally comprising:
storing in the cloud fact table aggregated data aggregated from a subset of data stored in the plurality of cloud dimension tables, the aggregated data being accessible from the cloud fact table using cloud identifiers, without a necessity of using dimension identifiers.

13. A method as in claim 8 additionally comprising:
populating the plurality of cloud dimension table and the cloud fact table with external data or date from an existing data warehouse.

14. A method as in claim 8 additionally comprising:
setting up a technical infrastructure that performs the following functions on data in the cloud storage area:
data read;
data write;
authorize data access;
broadcast data;
archive data
index data,
compress data;
validate data;
execute operations using data;
implement business rules and technical definitions of tables.

15. A method for accessing data in a cloud storage area, the method comprising:
accessing the data in a plurality of master data tables, the master data tables including surrogate identifiers, each surrogate identifier identifying one from a plurality of master data table domains inside a master data table from the plurality of master data tables;
accessing the data in a plurality of dimension tables, the dimension tables using the surrogate identifiers to link to the master data table domains within the master data tables;
accessing the data in a fact table, the fact table storing dimension identifiers that provide links to dimension tables in the plurality of dimension tables; and,
accessing a cloud storage area, the cloud storage area including
a plurality of cloud dimension tables, each cloud dimension table in the plurality of cloud dimension tables storing summary characteristics and each cloud dimension table in the plurality of cloud dimension tables associating a separate cloud identifier with each entry of summary characteristics, and
accessing a cloud fact table, the cloud fact table storing aggregated data representing key performance indicators, the cloud fact table including a plurality of cloud identifier columns in which cloud identifiers are stored, wherein each cloud identifier column is dedicated to a single associated cloud dimension table from the plurality of cloud dimension tables, so that each cloud identifier column only stores cloud identifiers for a single cloud dimension table.

16. A method as in claim 15 additionally comprising:
accessing master data keys and surrogate identifiers in the plurality of master data tables.

17. A method as in claim 15 additionally comprising:
accessing the data from the cloud fact table wherein the cloud fact table consists of aggregated data aggregated from a subset of data stored in the plurality of cloud dimension tables, the aggregated data being accessible from the cloud fact table using cloud identifiers, without using dimension identifiers.

18. A method as in claim 15 additionally comprising:
accessing a cloud dimension table from the plurality of cloud dimension tables and the cloud fact table to meet data movement requirements between software custom built applications and a plurality of cloud storage areas within a data warehouse environment that store more data than the cloud storage area.

19. A method as in claim 15 additionally comprising:
setting up a technical infrastructure that performs the following functions on data in the cloud storage area:
data read;
authorize data access;
validate data;
secure data;
user applications.
